(19) United States
(12) Patent Application Publication
(10) Pub. No.: US 2009/0284655 A1
(43) Pub. Date: Nov. 19, 2009

(54) TABLE WITH A MONITOR AND RELATED DATA-SYSTEM, ESPECIALLY FOR HOME USE AND FOR USE IN PUBLIC ROOMS EQUIPPED WITH THIS TABLE

(76) Inventor: Petr Lukes, Praha (CZ)

Correspondence Address: NOTARO & MICHALOS P.C., 100 DUTCH HILL ROAD, SUITE 110, ORANGEBURG, NY, 10962-2100, US

(21) Appl. No.: 12/374,055

(22) PCT Filed: Jul. 17, 2007
(86) PCT No.: PCT/CZ2007/000070

§ 371 Date: Jan. 16, 2009

(30) Foreign Application Priority Data
Jul. 18, 2006 (CZ) PV 2006-464

(51) Int. Cl. H04N 7/00; A47B 21/00; A47B 21/007

(52) U.S. Cl. 348/552; 108/50.02; 348/E07.001

(57) ABSTRACT

The invention is related to a table with a monitor, consisting of a table board and of a support construction with at least one supporting or hanging unit, where substantive is, that the board of this table (10) is created in the form of at least one flat monitor (1). Further is concerns a data system, especially for home use and for applying in public rooms, containing at least one flat monitor, which is fixed in the table with a monitor, where this data system is adjusted for a variable data-supplying to at least one flat monitor, acting as a table board, and where the most substantive is, that the data-system contains further at least one computer (20) with a connection to Internet (21), TV-set or receiver (22), a video-recorder and video-decoder (23), for static pictures and/or movies, and a coordinating, governing and distributing central unit (24).

### TECHNICAL FIELD

The invention concerns to multi-use tables, especially work tables, restaurant tables, tables for amusement installations and similar tables, where a table board comprises a monitor, adjusted for a projection of pictures or video, programs, data, etc. The invention concerns to data systems, especially for use in public rooms equipped with this table, as for example restaurants, conference rooms, study centers, schools, etc., but the same use is possible at home, when installing this table or tables with a monitor, adjusted for being connected to some source and program center.

### BACKGROUND ART

Now, a use of monitors is, in principle, well known, and the same in a mechanical connection with tables. For example tables are known for bearing a separate monitor in a simple way. There installations for fixing a monitor on a table, with a possibility of tilting or rotating of this monitor are created, or similar constructions are known, where monitors are adjusted to dive into a table. Those constructions are known, using both monitors of electron-tube-type and of LCD-type and similar. Further, a positioning of monitors, where fixing them to tables is not variable, is known, too. When using those tables with monitors just described no tilting or diving of monitors on tables is available and only a use as an usual TV-set or as an usual video-monitor is possible. Then some type of fixing of a monitor on a table is solved, in various mechanical ways, and frequently a tilting or rotating type of fixing is used. Those apparatus as above are described, for example, in following documents: CN2751650Y, CZ PV 1999-2882, U.S. Pat. No. 6,286,440, DE 10109137, WO 03/047390. All documents cited show the way to adjust a table for fixing a monitor, where tilting, rotating or diving of this monitor is available. Where a board of table should be plain and having no grooves, extensions or other disturbances, from a point of view of everyday use of its surface or of its maintenance and cleaning, there those types of table-monitor installations just described suffer from some disadvantages, as especially a limited working area on the surface of this table and the grooves or extensions on the surface of a table. When it is necessary to fulfill a decorative function, too, of a set, containing a table and a monitor, then those sets known in the range of state-of-the-art constructions are able to fulfill this function in a limited way only. Those best similar constructions having monitor-area covering a relative small part of a board of table. So those known table-and-monitor sets work as a table with a not fully integrated accessories only, not as integrated unit with nearly no limits for all related functions, both of a table and of a monitor.

### DISCLOSURE OF THE INVENTION

Disadvantages described above are significantly reduced and a multi-use table with a plain and smooth upper surface, where a surface with no grooves or extensions is possible to create, and where a monitor is integrated, is designed, when taking a table with a monitor according to the invention, where it contains a table board and a supporting skeleton with at least one supporting or hanging unit and where the most substantive is that the board of this table is created in the form of at least one flat monitor, preferably in the form of plasma- or LCD-monitor, and where, preferably, the monitor is fixed in a fortifying frame, which is connected with at least one supporting or hanging unit of this table, and where the monitor being covered by a protective cover having a flat upper surface, this protective cover being produced from a firm transparent or translucent material, or from mirror-like material, which is adjusted to change to transparent material, when being lighted from backside. Preferably a transparent or translucent material is transparent glass or hard plastic. Preferably an antireflex sheet or lining is created on the surface of a protective cover. Further, it is advantageous when an active working surface of a monitor covers at least 50% of the entire surface of the table board, preferably at least 80% of the entire surface. Sometimes it is advantageous if a flat monitor consists of at least two part-monitors, which are fixed side-by-side in the fortifying frame. It is advantageous, too, when a monitor having a form of active touch-display. It is necessary to remark here that a term monitor used in this specification means every type of monitor or any technical equivalent of this one, not important if as its name a monitor, screen, display or similar is used. When an independency on an outer energy source is needed, it is advantageous to create a table with a monitor having its own energy source, at least in a form of an electric accumulator. This own energy source could be chosen in another form, too, for example in the form of engine-generator unit, or photovoltaic cells battery or wind-generator, or so, but mostly it would not be better for use in practice. It could be advantageous, too, when at least a source cable and/or a charging cable, leading to a monitor or to monitors, is conducted through one of supporting or hanging units of this monitor, which unit is hollow or is equipped with a parallel hollow cover or a tunnel. Sometimes it could be advantageous, if a cable is free hanging, for example from a ceiling. As supporting unit or units table legs are used. Concerning a working board of a table with a monitor, this could be fixed in a movable support, which is angulary- and/or high-adjustable. So then there is possible to adjust a working board for a variety of purposes, to an ergonomic position, when using a table with a monitor, according to the invention, as a school or study table or as a design table, etc. When using this table as a restaurant table, it is desirable to maintain its horizontal position and when a tilting-type is used there, it is possible to adjust this horizontal position in spite of a table being installed on non-horizontal ground. In the case just described two directional tilting or adjusting is recommended. Concerning a further equipment of this table with a monitor, there is advantageous to create this one containing a loudspeaker and/or a microphone, or a loudspeaker set and/or a microphone set, which is integrated into a table body or into a flat monitor body. What is substantive, too, it is creating of a data system, especially for home use and for applying in public rooms, containing at least one flat monitor, which is fixed in the table with a monitor, where this data system is adjusted for a variable data-supplying to at least one flat monitor, acting as a table board, and where it is substantive that the data-system contains further at least one computer with a connection to Internet, TV-set or receiver, a video-recorder and video-decoder, for static pictures and/or movies, and a coordinating, governing and distributing central unit. It is advantageous when data links between data units in the table with a monitor and the data units out the table are provided on a principle of short-range wireless links, for example Bluetooth, WIFI, infrared radiation transmission, or in common a radio-transmission of a low energy RF-output, etc. Further, it is advantageous when a coordinating, governing and distributing central unit is created as computer program bloc in a computer. Another advantageous variety is so created that at least one computer is fixed in a table with a monitor, or in a housing of this flat monitor. In this case a computer accessories contains a spare active source of electrical energy. Or, in another case, it is advantageous if at least the coordinating, governing a distributing central unit is located out of a place or room with a table or tables with a monitor and a connection to this place or room with a table or tables with a monitor is provided as long-distance data-transmission, advantageously as the Internet and/or the Intranet and/or the telephone net, which is a wiring-net or a wireless net. Further the system, advantageously, contains cameras, located on the table or in its surroundings, which cameras are connected to a computer and/or to a coordinating, governing and distributing central unit. It is advantageous and useful, too, if at least one microphone and/or at least one camera is connected to a decoding and/or identifying bloc, which is created in a coordinating, governing and distributing central unit or in a computer, which is connected to this center and which is adjusted to working governing and/or identifying voice and/or picture input data.

This way it is achieved the creating of a multi-function table, a table board of which having fully plain and flat upper surface, not interrupted by grooves or protrusions, where all the surface of this table, or its substantive part, is able to provide wide range of graphic services or activities, both static or dynamic. It is possible to see TV or video-record there, or it is possible to use a surface of the table as a variable game-board for any game, or it is possible to create a static or slightly dynamic graphics on the table, similar to a typical table couvert. Or it is possible to show a day-menu, meaning meals and dring, described both by text and picture data and to collect then, when using the table with a monitor according to the invention, customers orders, too. Of course, an analogous use of this table in conference rooms, during new products presentations or in schools for studying purpose is advisable, too.

### BRIEF DESCRIPTION OF THE DRAWINGS

The invention is described and presented in detail using an advantageous example embodiment, with the drawings enclosed, where

FIG. 1 shows a table with a monitor, in a longitudinal vertical section,

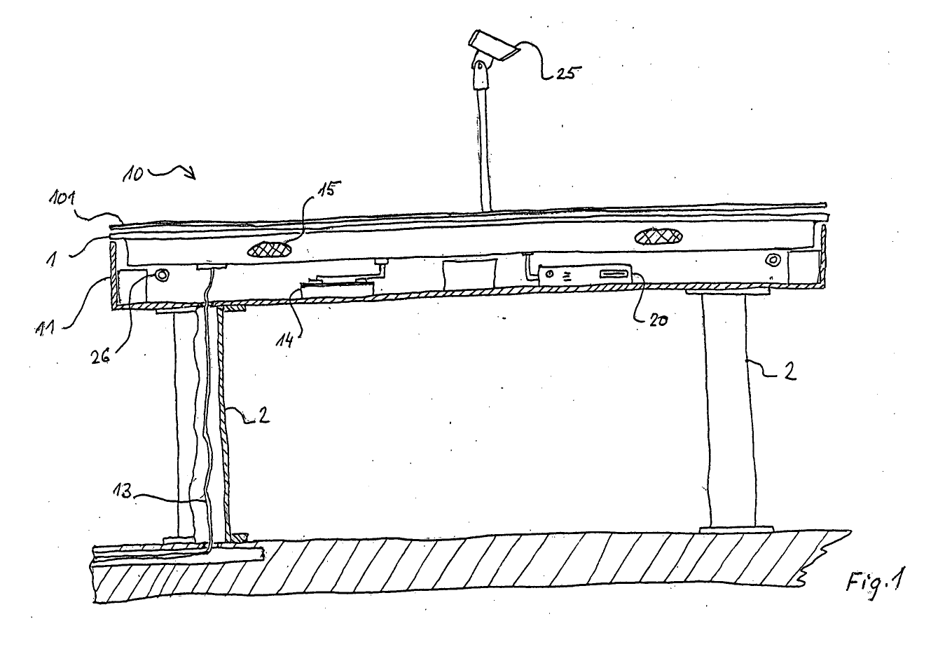

FIG. 2 shows the same table, now seen in an upper view, and

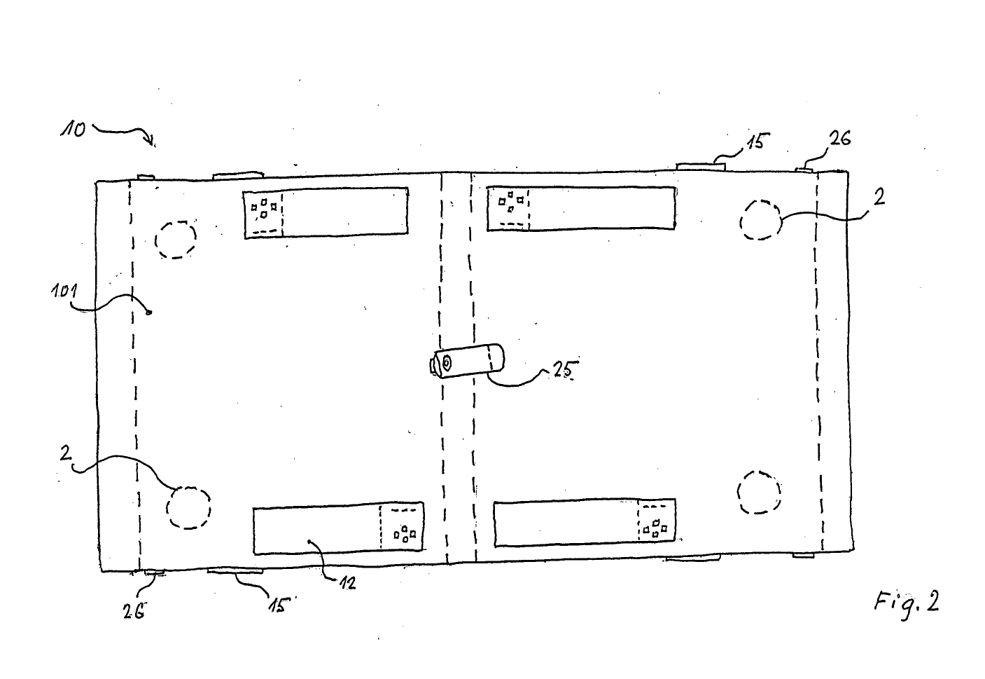

FIG. 3 shows a bloc-scheme of one variety of the data-system, intended for use in public rooms, equipped with those tables with a monitor.

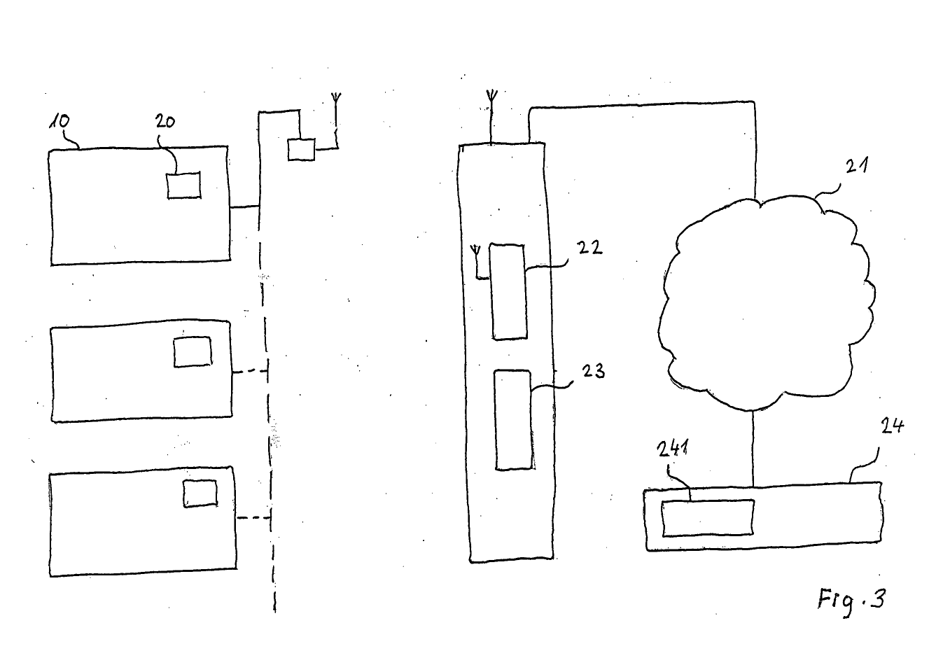

### MODE FOR CARRYING OUT OF THE INVENTION

A table 10 with a monitor, as an example embodiment of the invention, contains a flat monitor 1, fixed in a frame 11, to which legs 2 of the table 10 are fixed. This is a multi-function table with a quality, flat and plain upper surface, without any grooves or protrusions and a flat monitor is fully integrated therein. The table 10 with a monitor consists of a table board, created as a flat monitor 1 in a frame 11, and of a supporting construction with at least one supporting or hanging unit, where here supporting units are created in the form of table legs 2 of the table 10. The most substantive is that the board of this table 10 is created in the form of at least one flat monitor 1, preferably here in the form of LCD-monitor, which here is fixed in a fortifying frame 11, which is connected with four supporting units of this table 10, having a form of legs 2 of this table 10, and where the monitor being covered by a protective cover 101 having a flat upper surface, this protective cover 101 being produced from a firm light- or light-material, here in the form of a glass. Here an antireflex sheet is created on the surface of a protective cover 101. In common, it is not necessary in all cases to use a protective cover 101, for example made of glass, for protecting a monitor 1. Sometimes the surface of a monitor 1 is just originally made from a sufficiently hard material. Such a material should be friction-temperature- and chemical resistant. Usually all those features seem to be fulfilled by said glass material, where for greater mechanical load resistance thick-walled glass board or multisheet glass with plastic connecting sheets is usually used, and using of supplemental protective plastic foil is possible, too. Further, an active working surface of a flat monitor 1 covers here 95% of the entire surface of the table board. In common, a part covered by a monitor 1 could be smaller, but when creating a table according the invention it is substantive to cover a substantive part of an upper table surface and when a table 10 is so constructed that a table board is based on a flat monitor 1, which is integrally build in this table 10 and so this monitor forms a substantive construction and function part of a whole table-monitor unit, it is to be understood that a part of table board, covered by a monitor 1, takes at least 50% of the entire surface of this table board. Sometimes it is advantageous if a flat monitor 1 consists of at least two part-monitors 1, which are fixed side-by-side in the fortifying frame 11. This variety, just described, is not in present example shown, but it could be useful when building relative big tables 10, where so big monitor 1 is usually very expensive or simply is not available on usual market. Or using of more monitors 1 could be advantageous when a table is supposed to work as a playtable for some play with more players. The monitor 1 having here a form of active touch-display, which allows here to use some part of this table 10 as an external input device or unit, for example instead of a computer mouse or instead of a keyboard, or similar. Of course, using of further mouse or keyboard in the role of further input device is not limited this way. If the table 10 is used as a restaurant table it would be possible to use it as a menu with text and picture parts and also it would be possible to order a meal using a monitor 1 as a touch-display keyboard, or a possibly appears here to ask about ingredients, about an expiration date and about a calorific value of the meal which is to be ordered. When an independency on an outer energy source is needed, it is advantageous to create a table 10 with a monitor 1 having its own energy source 14, at least in a form of an electric accumulator. This own energy source could be chosen in another form, too, for example in the form of diesel or petrol engine-generator unit, or photovoltaic cells battery or wind-generator, or so, but mostly it would not be more advantageous for use in practice. In consequence of state support of using “green” energy, there is possible that some of those said alternative sources of energy could appear more advantageous in future. The reasons for using said alternative sources of energy could be that of advertisement or that of teaching or studying. For example when a table with a monitor is installed in school or in restaurant, so in case of incorporating photovoltaic cells or wind generator as an energy source, great didactic or advertising effect will be achieved, supposing a position of the device is on a relevant windy or sunny place. Source cable and a charging cable 13, leading to a monitor 1 is conducted here through one of supporting or hanging units of this monitor, which unit is created here as a hollow leg 2 of a table 10. In common, supporting unit of a table 10 could have a form of side-mounted console, fixed on the wall, etc. Concerning a working board of a table with a monitor, here constructed as a frame 11 with a flat monitor 1, this could be fixed firmly, as here it is provided, or fixed in a movable support, which is angulary- and/or high-adjustable. So then there is possible to adjust a working board for a variety of purposes, to an ergonomic position, when using a table with a monitor, according to the invention, as a school or study table or as a design table, etc. Concerning the variety here presented, it is shown here a set of loudspeakers 15, integrally built in a monitor 1.

What is substantive, too, it is creating of a data system, containing flat monitors 1, which are fixed in the tables 10 with a monitors 1, where this data system is adjusted for a variable data-supplying to at those flat monitors 1, acting as a board of those tables 10, as just described. The data-system contains further a computer 20 with a connection to Internet, TV-set 22, a video-recorder and video-decoder 23, for static pictures and/or movies, and a coordinating, governing and distributing central unit 24. As a video decoder 23 there a DVD device is used, with relevant recording media, and memory media in computer 20 is here used, too. Data links between data units in the table 10, which are the monitor 1 and a computer 20, and the data units out of the table 10, which are TV-set 22 and video-decoder 23, and a central unit 24 are provided on a principle of short-range wireless links, where here Bluetooth system is used. Here a computer 20 is fixed in a set of a table 10 and a monitor 1, and, more detailed, in a housing of a flat monitor 1. With a computer 20 a spare energy source 14 is mounted, which is created as an active spare source of the UPS-type. This source not only secures energy supplying with constant voltage, but in case of failing the outer source of energy it governs a computer 20, for example by order to saving data and similar. Computer 20 is equipped by all usual periferie, or at lest by inputs for them, for example for DVD and CD mechanics, memory card reader, etc., or this equipment could be build in a computer 20 as it is known. Concerning a coordinating, governing and distributing central unit 24, it is placed out of a room with tables 10 and it is connected to this room by Internet 21, using usual telephone net here. The reason of this adjustment is here the organizing structure of the provider of a restaurants system, using the tables with monitor, where here a governing of a menu 12 and a governing of advertising activity is centralized in an unique point. The data system contains here three cameras 25, located in its surroundings of a table 10, which cameras 25 are connected to a coordinating, governing and distributing central unit 24 and they take an activity around the table, which is here installed as a restaurant table 10, of course according the wishes and under a control of those people, sitting there. So a record of a exceptional dinner, for example, could be made, etc. When using a table 10 as a playing table, so there the records of cameras 25 should be handled in a usual way, as in casinos, for ex., it works.

The way of use of this device is as follows. By creating this multi-function table according the invention, enables a broad scope of use, because a table board having fully plain and flat upper surface, not interrupted by grooves or protrusions, where all the surface of this table, or its substantive part, is able to provide wide range of graphic services or activities, both static or dynamic. It is possible to see TV or video-record there, or it is possible to use a surface of the table as a variable game-board for any game, or it is possible to create a static or slightly dynamic graphics on the table, similar to a typical table couvert. Or it is possible to show a day-menu, meaning meals and dring, described both by text and picture data- and to collect then, when using the table with a monitor according to the invention, customers orders, too. Of course, an analogous use of this table in conference rooms, during new products presentations or in schools for studying purpose is advisable, too.

In detail, the function is as follows. A static or dynamic picture is created on the screen of a monitor, advantageously in connection with a data system. A picture is introduced in a monitor 1 from a TV-set 22, or from a record of TV or from another source, using any recording media, for ex. cassette or DVD decoder, or memory media of a computer 20, or just another external device, computer governed for ex., etc. A governing of a picture at a monitor 1 goes on from a table 10, or from persons, controlling a central unit 24. This could be provided in manual or automated way, according to a program equipment of central unit 24, which is usually constructed as a computer. Personal governing, using a keyboard, a computer mouse, or picture keyboard or similar on a monitor 1 is possible, too, especially when the monitor is here provided as a touch-display. In a variety with data system there would be a priority of central governing of the system, using a central unit 24, orders or governing introduced from a table 10 would have a lower priority. So, for example by a restaurant table a content of menu 12 is given by a central unit 24, which, under governing of people sitting by this table, appears on the flat monitor 1, and according to a further order from a table the choice of meal is transferred in a central unit 24, where, according to its content, this choice is transmitted to the kitchen. Further, according partly to governing by people sitting by the table, partly to the data from central unit 24, there appears on the table, on its flat monitor 1, a static graphics, or other amusing or advertising or calming program. Also it is possible to do a monitoring of a growing debit note, relevant to this table, both individual and concerning all persons by the same table. Analogous broad scope of use is available by a table in situation of working table or a table in school, etc. Functions of the table according to the invention are not limited and it is possible to find more possibilities there. For example at least one microphone 26 and/or at least one camera 25 is to be connected to cosiny and/or decoding block 241, created in a central unit 24, or in a computer 20, which is connected to a central unit 24, and which is adjusted for working a governing and/or identifying voice or picture input. When using this type of input, capable to identify persons using their voice and/or picture, it is possible to apply orders, to govern functions of a table 10, to communicate with a waiter and to do a reliable identification of persons and also for ex. it is possible to ask about banking situation or a customer or to apply discounts for frequent visitors, etc., etc.

### INDUSTRIAL APPLICABILITY

Table with a monitor according to the invention can be used in home or public rooms, especially in restaurants, but also in conference rooms, for new products presentations, or in schools of all types and degrees, for teaching purpose, for example as a display-equipped school table, or another use for artists, designers and other profession is possible and advisable.

1. Table with a monitor, consisting of a table board and of a support construction with at least one supporting and hanging unit, characterized in, that the board of this table (10) is created in the form of at least one flat monitor (1).

2. Table with a monitor according to claim 1, characterized in, that the flat monitor (1) is created in the form of plasma- or LCD-monitor.

3. Table with a monitor according to claim 1 and 2, characterized in, that the flat monitor (1) is fixed in or on a fortifying frame (11), which is connected with at least one supporting or hanging unit of this table (10), and where this monitor (1) being covered by a protective cover (101) having a flat upper surface, this protective cover (101) being produced from a firm transparent or translucent material, or from mirror-like material, which is adjusted to change to transparent material, when being lighted from backside.

4. Table with a monitor according to claims 1 to 3, characterized in, that a transparent or translucent material of a protective cover (101) is transparent glass or hard plastic.

5. Table with a monitor according to claims 1 to 4, characterized in, that an antireflex sheet or lining is created on the surface of a protective cover (101).

6. Table with a monitor according to claims 1 to 5, characterized in, that an active working surface of a flat monitor (1) covers at least 50% of the entire surface of the table board.

7. Table with a monitor according to claims 1 to 6, characterized in, that an active working surface of a flat monitor (1) covers at least 80% of the entire surface of the table board.

8. Table with a monitor according to claims 1 to 7, characterized in, that a flat monitor (1) consists of at least two part-monitors, which are fixed side-by-side in the fortifying frame (11).

9. Table with a monitor according to claims 1 to 8, characterized in, that a monitor (1) having a form of active touch-display.

10. Table with a monitor according to claims 1 to 9, characterized in, that a table (10) with a monitor (1) having its own energy source (14), at least in a form of an electric accumulator.

11. Table with a monitor according to claims 1 to 10, characterized in, that at least a source cable and/or a charging cable (13), leading to a monitor (1) or to monitors (1), is conducted through one of supporting or hanging units of this monitor (1), which unit is hollow or is equipped with a parallel hollow cover or a tunnel.

12. Table with a monitor according to claims 1 to 11, characterized in, that at least a source cable and/or a charging cable (13), leading to a flat monitor (1) or to monitors (1) is free hanging.

13. Table with a monitor according to claims 1 to 12, characterized in, that as supporting unit or units table legs (2) of the table (10) are used.

14. Table with a monitor according to claims 1 to 13, characterized in, that a working board of a table with a monitor is fixed in a movable support, which is angulary- and/or high-adjustable.

15. Table with a monitor according to claims 1 to 6, characterized in, that a table with a monitor contains a loudspeaker (15) or loudspeaker set and/or a microphone (26) or a microphone set, which is integrated into a table (10) body and/or into a flat monitor (1) body.

16. Data system, especially for home use and for applying in public rooms, containing at least one flat monitor, which is fixed in the table with a monitor, according to claims 1 to 15, where this data system is, adjusted for a variable data-supplying to at least one flat monitor, acting as a table board, characterized in, that the data-system contains further at least one computer (20) with a connection to Internet (21), TV-set or receiver (22), a video-recorder and video-decoder (23), for static pictures and/or movies, and a coordinating, governing and distributing central unit (24).

17. Data system, according to claim 16, characterized in, that links between data units in the table with a monitor and the data units out the table are provided on a principle of short-range wireless links.

18. Data system, according to claim 16 to 17, characterized in, that a coordinating, governing and distributing central unit (24) is created as computer program bloc in a computer (20).

19. Data system, according to claim 16 to 18, characterized in, that at least one computer (20) is fixed in a table with a monitor, or in a housing of this flat monitor (1).

20. Data system, according to claim 19, characterized in, that computer accessories of computer (20), which is situated in a table (10) with a monitor (1) or in a body of a flat monitor (1), contains a spare active source of electrical energy.

21. Data system, according to claim 16 to 20, characterized in, that at least the coordinating, governing a distributing central unit (24) is located out of a place or room with a table or tables (10) with a monitor (1) and a connection to this place or room with a table or tables (10) with a monitor (1) is provided as long-distance data-transmission.

22. Data system, according to claim 21, characterized in, that long-distance transmission is provided as the Internet data transmission (21), and/or the Intranet and/or the telephone net, which is a wiring-net or a wireless net.

23. Data system, according to claim 16 to 22, characterized in, that the system contains at least further one camera (25), located on the table (10) or in its surroundings, which camera is connected to a computer (20) and/or to a coordinating, governing and distributing central unit (24).

24. Data system, according to claim 23, characterized in, that at least one microphone (26) and/or at least one camera (25) is connected to a decoding and/or identifying bloc (241), which is created in a coordinating, governing and distributing central unit (24) or in a computer (20), which is connected to this central unit (24) and which is adjusted to working governing and/or identifying voice and/or picture input data.
